(19) United States
(12) Patent Application Publication
(10) Pub. No.: US 2004/0251062 A1
(43) Pub. Date: Dec. 16, 2004

(54) Flexible caterpillar belt and skis for a 4 x 6 utility vehicule

(76) Inventor: Stephane DeLisle, Prevost (CA)

Correspondence Address: Stephane DeLisle, 1518 Montee Sauvage, Prevost, QC, JOR1TO, CA

(21) Appl. No.: 10/758,491

(22) Filed: Jan. 16, 2004

(30) Foreign Application Priority Data
Jan. 13, 2003 (CA) CA 2.416.561

(51) Int. Cl. B62D 55/00

(52) U.S. Cl. 180/9.21

(57) ABSTRACT

A removable equipment for winter use meant to convert a six wheeled utility vehicule in a crawler belted vehicule which the rear four wheel drive pneumatic tires propulse and the two front ones manoeuvre, that include a belt type caterpillar made of a rubber band belt material incorporating individual replacable traction segments that simultaneously tract and guide the said caterpillar belt in movement over the tires and structurally connected at both ends of the said belt with a detachable fastening device to encompass parallel to a pair of pneumatic tires of the rear portion, and box shaped skis that receive the pair of front pneumatic tires and layed in place with a rubber belt set with a fastening device surrounding the wheels for accurate magnability.

### CROSS REFERENCE TO RELATED APPLICATION

CA Patent Documents

| | | |
|---|---|---|
| 2210818 | July, 1997 | Honda |
| 2296781 | January, 2000 | Hugron |

### BACKGROUND OF THE INVENTION

1. Field of the Invention

The present invention relates to the field of a 4×6 utility vehicule and is particularly concerned with an adapted equipment used to convert in a caterpillar tracted vehicule for winter use.

2. Summary of the Invention

Caterpillar track vehicule are useful and manoeuvrable in different conditions such as winter season. The type of vehicule mentioned above is used in light maintenance work in a number of activity sector such as public parks, farms, building sites or else sports and it could be used for the transportation of equipments, workers, or for carrying heavy loads. But this type of vehicule equiped with pneumatic tires and with its low profile underneath frame is practically inoperative on snow-covered surfaces, ice and irregularity of the terrain and have for result to get the vehicule bogged down and because of this lack of performance during this period, owners of utility vehicule are resigned to put away for the winter season.

The present vehicule is designed to fulfil its functions only on hard bases or so and are useless in certain conditions like the winter season. This problem has been recognized in the past and owners of that type of vehicule are eager to find efficient solution, thereby, a so called utility vehicule is an essential tool for maintenance operations and gain in popularity. The so called utility vehicule is defined by a rear portion composed by a set of four wheels drive that propulse the vehicule and a front portion composed by a set of two wheels rotating freely on their axes is for the manoeuvrability. The only alternative proposed is the use of chained wheel traction mounted around each driving wheels. Although partly solving the problem of traction during the winter season such piece of equipment still suffer from a set of drawbacks. Indeed, in the case of switching from icy surfaces or compact snow bases to an aboundant snow-covered soil, its unefficient traction will instantantly bog down the vehicule. Also, the chained wheels traction vehicule are restrained to operate on potentially hard surfaces to conserve its manoeuvrability otherwise it will result of an abusive use of the mechanical portion.

During the normal use of the so called utility vehicule originally mounted with pneumatic tires and initially built to travel on hard soil have to restrain its use to a certain period of time over a year. The traction of the wheels itself is therefore compromised without substantial equipment. Eventually the needs for an extensive use of the vehicule throughout the winter season may be enable to function without appropriate equipment. Thus, the problem of having difficulty manoeuvring on snow with the vehicule still at least partially remains.

This problem has been recognized in the past and adressed to by CA patent 2,210,818 naming Honda Giken Kugyo Kabushiki as the inventor and CA patent 2,296,781 naming Hugron, Denis P. as the inventor. The prior arts only partially solve the problem of manoeuvrability in winter conditions. The proposed solutions suffer from various drawbacks including lack of precision in the conception of the guiding parts of the flat shape belt over round edge profiled tire, and the absence of skis under the front wheels of the so called utility vehicule leads to the persisting problem of the appropriate traction of both ends of the said vehicule.

Accordingly, there exists a need for an improved equipment which is especially adapted for a utility vehicule. Advantages of the present invention include the fact that the proposed equipment allows the vehicule to have a perfect tracking and a superior control on all winter surfaces and demand no modification of the original conception of the vehicule for the technical assembling of both caterpillar belt and skis using fast attachment device to be held in place. Also, the proposed components assembly are designed so as to be both economical and ergonomical. Furthermore, the proposed pieces of equipments are designed as to be both aesthetical pleasing and reliable.

### BRIEF DESCRIPTION OF THE DRAWINGS

An embodiment of the present invention will now be described, by way of example, in reference to the following drawings in which:

FIG. 1, in an elevational view of the assembly, illustrates the caterpillar belt and ski in accordance with an embodiment of the present invention mounted on a conventional utility vehicule.

FIG. 2, in an exploded view of the caterpillar belt assembly illustrated in relation with one pneumatic tire of the rear portion of the vehicule in accordance with an embodiment of the present invention.

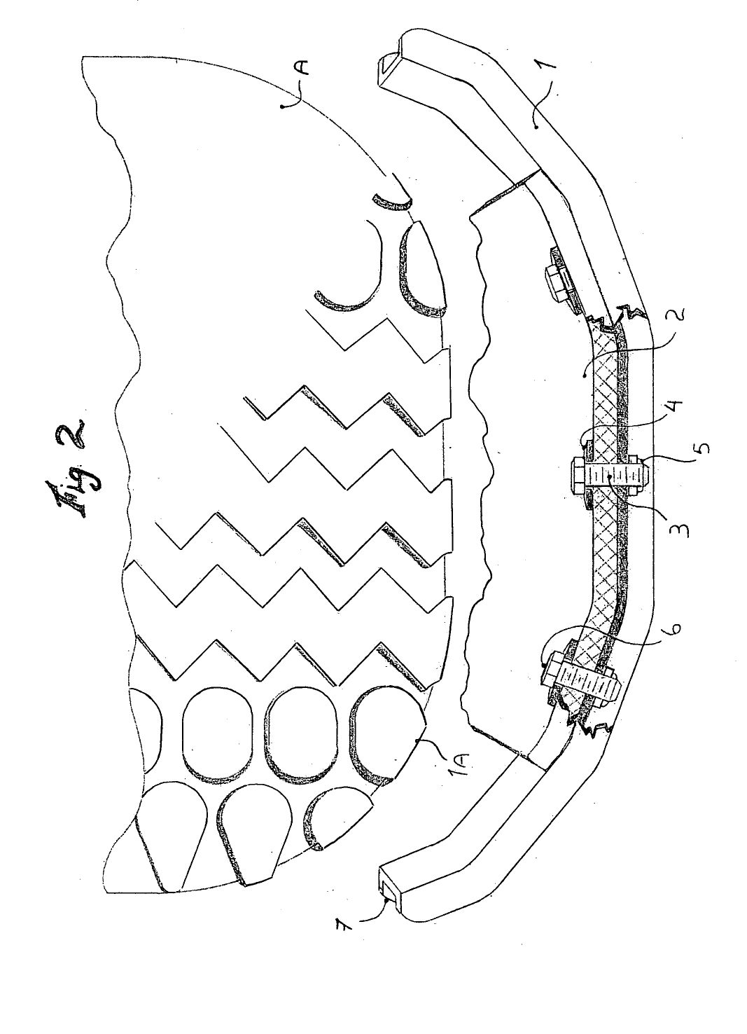

FIG. 3, in an elevational view and an upper cross sectional view of the cutting line I-I, of the ski assembly, illustrates in relation with one pneumatic tire of the front end of the vehicule in accordance with an embodiment of the present invention.

### DETAILED DESCRIPTION

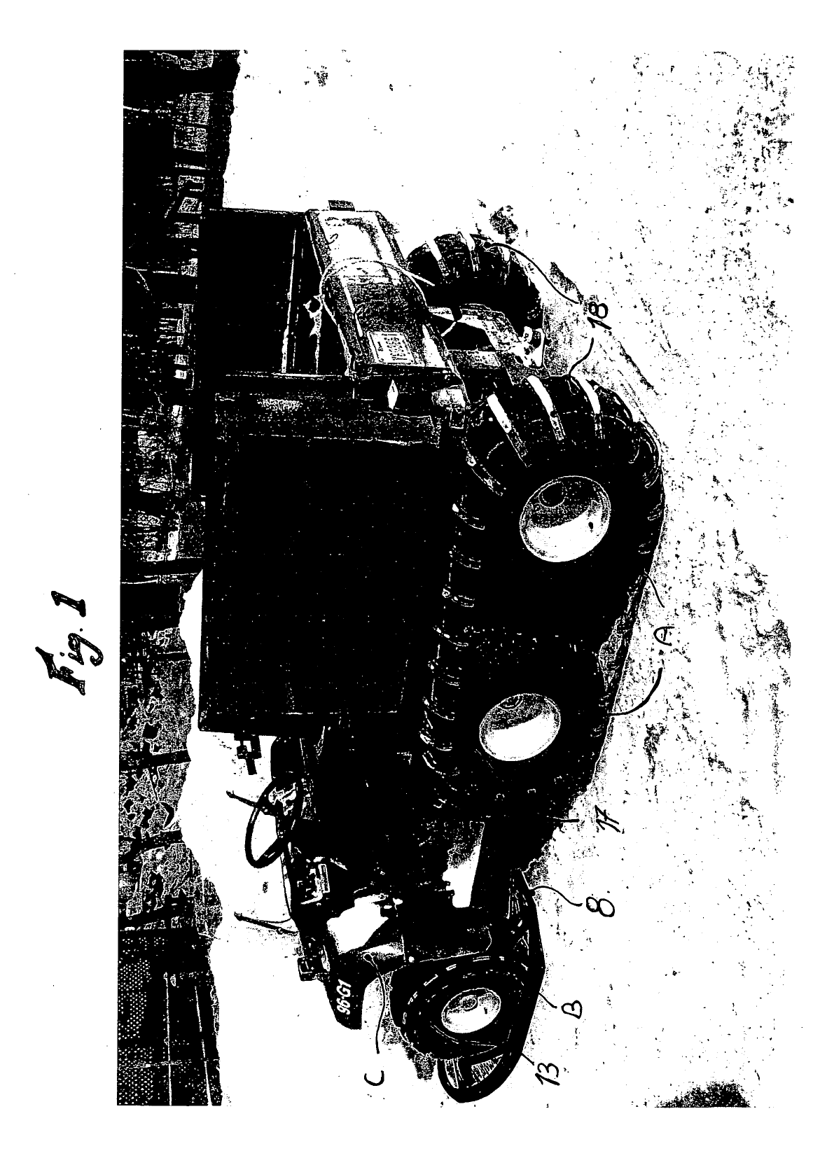

Referring to FIG. 1, there is shown the caterpillar belts 18 and skis in aim to provide traction and superior control of a utility vehicule and related to a winter use in accordance with an embodiment of the present invention. The equipment 18, 8 are shown encompassed directly over the pneumatic tires A and B of a utility vehicule C. The illustration shows the fastening devices 13, 17 structurally assemble both the skis and the caterpillar belt over the wheels. The traction segment 1 profiled to match the shape of the pneumatic tires A and exert a free contact laterally of the side of these ones in manner to ensure both, the constant alignment of the caterpillar belt in movement around the pneumatic tires A and a grip of the whole contact surface of the traction segment 1 with the ground, the said traction segment is assembled in the outer surface of a belt 2 that encompass a set of two wheels. Each traction segment 1 beforehand perforated and secured in place with three bolts 3 of which heads 6 lay on fender washers 4 on the interior side of the belt and the three nuts 5 are inserted between the double edge 7 of the said traction segment to ensure the assembly compression. The pneumatic tires A make contact with the interior surface of the belt 2 and the bolts heads 6 insert the rubber threads 1A of the tires rumbling strips, what prevent the caterpillar belt to skid out the pneumatic tires A surface when operating. A fastening device 17 for rubber belt (not illustrated) are fixed and retained on each end of the belt 2 and linked with a removable rod what form a mobile and mechanical joint like a hinge. The details above describe and summerize the elements of the caterpillar belt.

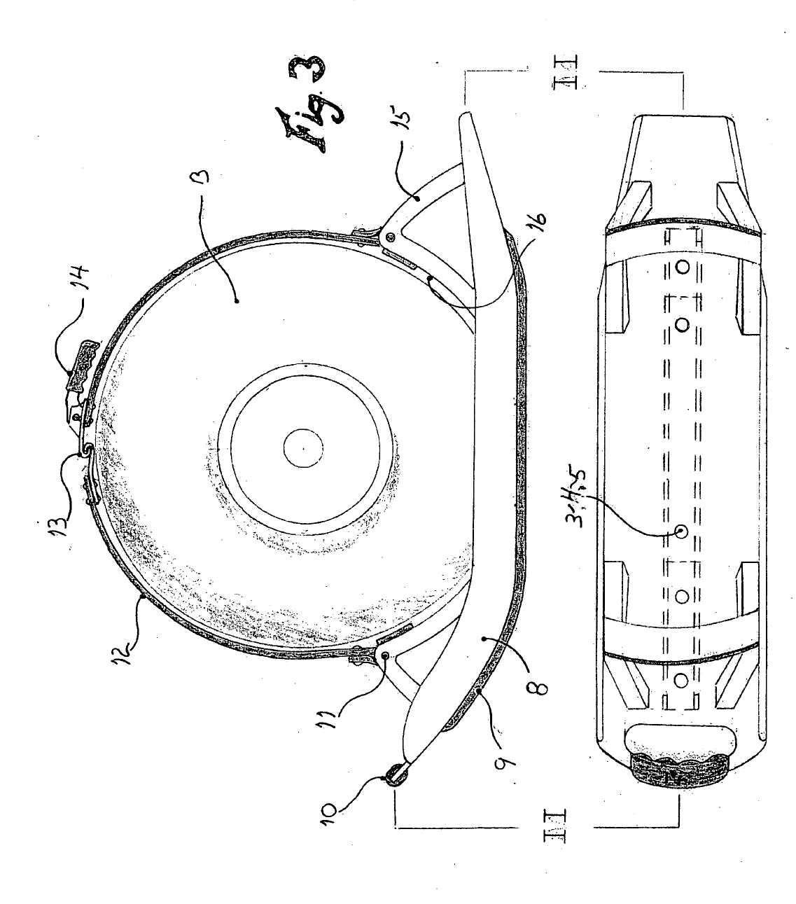

The skis 8 complement of the invention illustrated in FIG. 3, which the pneumatic tires B take place in position inside the integral support 15 welded to the ski frame of which the rumbling strips of the said tires made a radial contact on the interior 16 of the support 15, the parallel shaped box ski 8 interior ensure the contact with the tires side B to be maintained on a lateral position. A fastening belt 12 held by axes 11 on the top of both front and rear of the support 15 and diametrically encompass the tires B and linked on the superior part of the said tires with a fastening device 14 to ensure the right tension and the locking of the mechanism. A double edge ski guides 9 is beforehand perforated and secured in place with bolts, washers and nuts 3-4-5 and longitudinally centered under the skis 8 as illustrated in the cutting line I-I of the FIG. 3 which the function is to intervene in the manoeuvrability of the vehicule C. To end the description the technical components of the skis of the FIG. 3, an ergonomical handle 10 positioned on the front end as to aim an easier handling of the front part of the vehicule C so far to free from an obstacle or anyelse necessary manipulation.

Embodiment of the invention in which an exclusive privilege or property may be claimed include:

1. An equipment, that convert a utility vehicule 4×6 in a caterpillar track vehicule for a winter use, including a set of two (2)caterpillar belts parallel adapted that encompass the rear pneumatic tires of the said vehicule, in the way of guiding it by a series of identical double edge track segments that profiled to match the shape of the pneumatic tires A and simultaneously make contact transversally and perpendicularly allow to provide an acreased grip over the contact surface like snow-covered, icy condition or slop, including also a set of two (2) skis adapted and maintained in position by a diametrical attachment over the front pneumatic tires in a way of giving efficient manoeuvrability and floatability on snow and other surfaces mentioned above. The math set descibed get assembled direcly over the pneumatic tires and fastened with removable attachment and require no modifications of the original conception of the said vehicule.

2. An equipment as recited in claim 1, thus the caterpillar belt used for the traction of the propulsion rear portion, and the skis for the driving front portion of the so called utility vehicule.

3. An equipment as recited in claim 1 and claim 2, thus the caterpillar belt contains a defined number of track segments equally separated, their shapes are profiled to offer a grip on both transversally and perpendicularly and center mounted on a flexible rubber belt that encompass the external surface of a set of two (2) rear pneumatic tires, and thus the skis are individually assembled on each front pneumatic tires and fastened with a diametrical removable attachment centered on the said tire used for the maneouvrability.
